(19) United States
(12) Patent Application Publication
(10) Pub. No.: US 2024/0417603 A1
(43) Pub. Date: Dec. 19, 2024

(54) VERSATILE SELF-ADHESIVE MODIFIERS ON SILICONE RUBBER FOR BONDING PLASTIC AUTOMATICALLY

(71) Applicant: Nano and Advanced Materials Institute Limited, Hong Kong (HK)

(72) Inventors: Xianqiao LIU, Hong Kong (HK); Wai Ting Calford CHAN, Hong Kong (HK); Lap Yan Samson HUI, Hong Kong (HK); Wei KONG, Hong Kong (HK); Wai Hong LEUNG, Hong Kong (HK)

(21) Appl. No.: 18/336,055

(22) Filed: Jun. 16, 2023

(51) Int. Cl. C09J 11/06; C09J 183/04

(52) U.S. Cl. CPC C09J 11/06; C09J 183/04; C08K 5/11; C08K 5/5415; C08K 5/5435

(57) ABSTRACT

A composition of an enhanced silicone rubber with a specific formulation of versatile self-adhesive modifier is provided herewith, where the modifier is in the form of a pre-mix independent additive. The modifier can be applied to commercially available common liquid silicone rubbers, particularly food contact grade and non-post curing grade liquid silicone rubber, and the resulting enhanced liquid silicone rubber demonstrates significantly increased adhesive strength, particularly on plastic substrates. The modification of the liquid silicone rubber is efficient, the process of which does not require specific requirements or harsh conditions, and the process is highly cost-efficient.

### FIELD OF THE INVENTION

The present invention generally relates to organic polymer rubber modification and enhancement. More specifically the present invention relates to a versatile self-adhesive modifier used for food contact grade, non-post curing grade and high transparency grade liquid silicone rubber bonding with plastic substrates automatically.

### BACKGROUND OF THE INVENTION

Liquid silicone rubber is a rubber produced by a two-component system (i.e. component A and component B base resins), and is formed via reinforcing long polysiloxane chains with specific silica with the inclusion of a catalyst and a crosslinker. Liquid silicone rubber is distinct for its raw materials to be high consistency, and the mixture and generation of the product is also in liquid phase.

Liquid silicone rubbers have advantages over other rubbers or similar material due to its high biocompatibility, high durability, high chemical resistance, thermal stability and high electrical insulation. As a result, liquid silicone rubbers are widely used across a wide range of different industries for different applications and uses, and different formulations of liquid silicone rubbers are commercially available and easily accessible, and comes in specific grades including food grade, non-post curing, resistance to different mechanical and chemical damages.

It is common practice to enhance different properties of liquid silicone rubber through additives. Specifically, for promoting the adhesive strength of common liquid silicone rubber onto other materials, the most general and conventional way is to manually apply an adhesive primer. However, manual application would be labor-intensive and time-consuming.

To solve the above problems, self-adhesive LSR (SA-LSR) has been developed through chemically grafting reactive groups into component A or B base resins. Nevertheless, current commercially available SA-LSRs only offer bonding property to limited types of materials and require a different SA-LSR for various plastics. In addition, the applications from SA-LSR are restricted due to the limited availability for various regulatory grades (e.g. food contact, non-post curing) and functionalities, as well as high cost.

### SUMMARY OF THE INVENTION

It is therefore an objective of the present invention to provide a liquid silicone rubber with enhanced adhesive properties, versatile functionalities and regulatory compliance, and efficient and low-cost manufacture processes, which are compatible to existing LSR manufacturing processes.

In accordance with a first aspect of the present invention, a self-adhesive rubber composition having a tunable adhesion strength to plastic substrates is provided, comprising:
a commercially available common liquid silicone rubber substrate; and
a self-adhesive modifier additive selected from:
   a crosslinker selected from organosilane, organoacrylate or their derivatives;
   a curing agent selected from a platinum-based complex, an organic peroxide or its derivatives; or
   a mixture or combination thereof;
wherein the mass ratio of the silicone rubber substrate to the self-adhesive modifier additives ranges from 100:0.5 to 100:10.

In an embodiment of the first aspect, the plastic substrate is selected from polycarbonate; polybutylene terephthalate; polyetheretherketone or polyphenylsulfone.

In another embodiment, the liquid silicone rubber base comprises two components, wherein one is alkenyl-containing organopolysiloxane and the other is linear or branched organohydrogenpolysiloxane.

In other embodiment, the commercially available liquid silicone rubber substrate is selected from food-contact grade liquid silicone rubber; non-post curing liquid silicone rubber or high transparency liquid silicone rubber.

In yet another embodiment, the liquid silicone rubber base is selected from food-contact grade liquid silicone rubber; non-post curing liquid silicone rubber or high transparency liquid silicone rubber.

In another embodiment, the organosilane is selected from tetraalkylorthosilicates; (epoxy-organo)trialkoxysilane or any derivatives; copolymers or mixtures thereof.

In other embodiment, the tetraalkylorthosilicates has the following formula of Si(OR¹)₄, wherein R¹ is a monovalent hydrocarbon selected from:
a linear or branched alkyl group having equal to or less than 8 carbon atoms;
an alkoxy group having equal to or less than 4 carbon atoms; or;
a tolyl group.

In a further embodiment, the (epoxy-organo)trialkoxysilane has one of the following formulae:

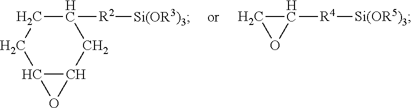

wherein R² is a divalent hydrocarbon group comprising 2 to 4 carbon atoms;
R³ and R⁵ are alkyl radicals comprising 1 to 3 carbon atoms; and
R⁴ is a divalent alkoxy group consisting 2 to 4 carbon atoms.

In yet other embodiment the organoacrylate is selected from ethyl acrylate; butyl acrylate; propyl acrylate; N,N-dimethylacrylamide; methacrylic acid; N-isopropyl acrylamide; 2-Hydroxy-ethyl-methacrylate; 3-[tris(trimethylsiloxy)silyl]propyl methacrylate; acrylate functional carbosilane molecule; methacrylate functional carbosilane molecule; dipentaerythritol pentaacrylate; ethoxylated pentaerythritol tetraacrylate; di-trimethylolpropane tetraacrylate; pentaerythritol triacrylate; trimethylolpropane triacrylate; ethoxylated trimethylolpropane triacrylate; or mixtures thereof.

In yet another embodiment, the organic peroxide is selected from di-benzoyl peroxide; tertiary butyl perbenzoate, dicumyl peroxide; 2,5-dimethyl-2,5-bis (t-butyl peroxy)hexane; bis(2,4-dichlorobenzoyl) peroxide; di-tertiary butyl peroxide; and mixtures thereof.

In another embodiment, the platinum-based complex is selected from platinum black; platinic chloride; chloroplatinic acid; a reaction product of chloroplatinic acid and a monovalent alcohol; a complex of chloroplatinic acid and an olefin; or platinum bisacetoacetate.

In other embodiment, the amount of tetraalkylorthosilicates is approximately 0.8 to 1.2 wt % relative to the weight of the liquid silicone rubber.

In yet another embodiment, the amount of (epoxy-organo)trialkoxysilane is approximately 0.8 to 4.8 wt % relative to the weight of the liquid silicone rubber.

In yet other embodiment, the amount of organoacrylate is approximately 0.8 to 3.6 wt % relative to the weight of the liquid silicone rubber.

In another embodiment, the amount of organic peroxide is approximately 0.4 to 1.8 wt % relative to the weight of the liquid silicone rubber.

In other embodiment, the amount of platinum-based complex is approximately 0.5 to 1000 ppm relative to the weight of the liquid silicone rubber.

In a second aspect of the present invention, a method of enhancing the adhesive strength of a liquid silicone rubber with the above-mentioned modifier is also provided herewith, comprising:
providing a liquid silicone rubber formed with commercially available liquid silicone rubber resin; and
introducing a tunable amount of the modifier of claim 1 to the liquid silicone rubber via the metering unit for pigment or additives of a liquid silicone rubber processor under a temperature of 20° C. to 30° C. and pressure of 0.3 MPa to 0.6 MPa;
wherein the adhesive strength of the enhanced liquid silicone rubber is tunable through adjusting the amount of the aforementioned modifier;
wherein the amount of modifier is less than 10 wt % of the liquid silicone rubber base; and
wherein the curing time is less than 10% longer than that of an unmodified liquid silicone rubber.

In an embodiment of the second aspect, the shear strength of the enhanced liquid silicone rubber is at least 0.6 MPa with the addition of modifier of at least 6 wt % of the liquid silicone rubber base.

### BRIEF DESCRIPTION OF DRAWINGS

For a better understanding of the various embodiments described herein and to show more clearly how these various embodiments may be carried into effect, reference will be made, by way of example, to the accompanying drawings, which show at least one example embodiment, and which are now described.

FIG. 1 illustrates the general process of manufacturing a self-adhesive liquid silicone rubber with the versatile self-adhesive modifiers of the present invention. With a choice of commercially available two-part common liquid silicone rubber, components A and B base resins are mixed with the versatile self-adhesive modifiers of the present invention added via the metering unit for pigment (i.e. C unit as illustrated) prior to mixing. The LSR manufacture procedures thereafter follows conventional LSR manufacture processes. The self-adhesive LSR produced may be used for automatic adhesion onto plastic surfaces or substrates.

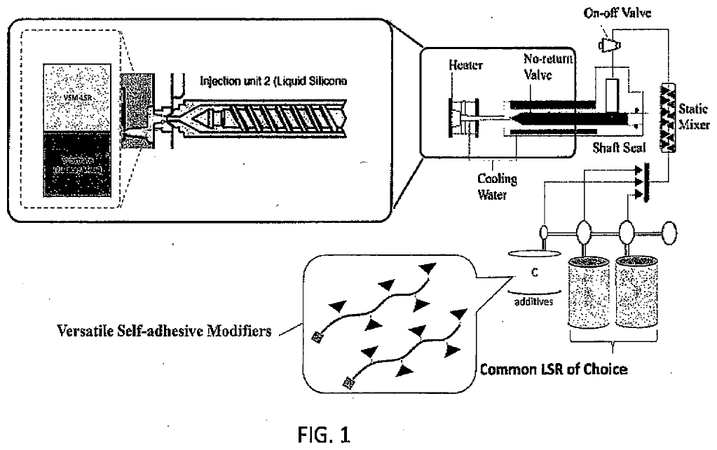

FIG. 2 is a general schematic of the self-adhesive rubber composition in the present invention. The versatile self-adhesive modifier is able to couple to the crosslinked liquid silicone rubber backbones, and at the same time attach to a plastic substrate.

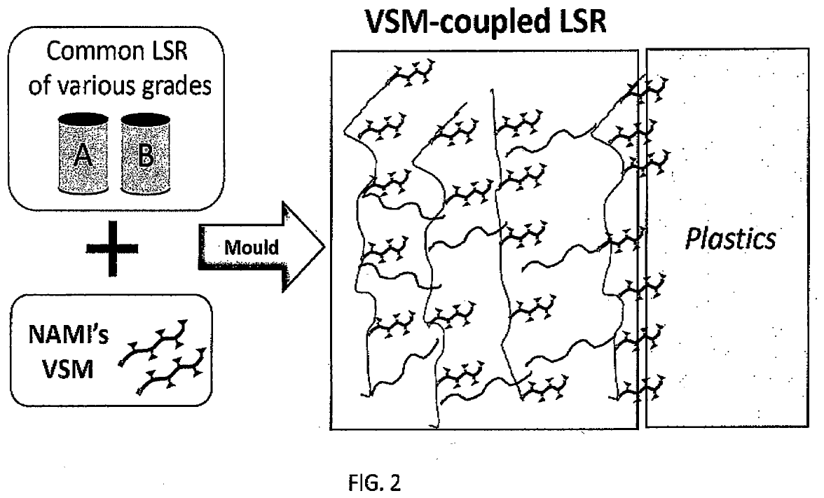

FIG. 3 shows an example of chemical structure of the versatile self-adhesive modifier. The vinyl group of the modifier serves to attach to the liquid silicone rubber backbones, and the epoxides and acrylates functional groups serve to bind to the different types of plastic substrates.

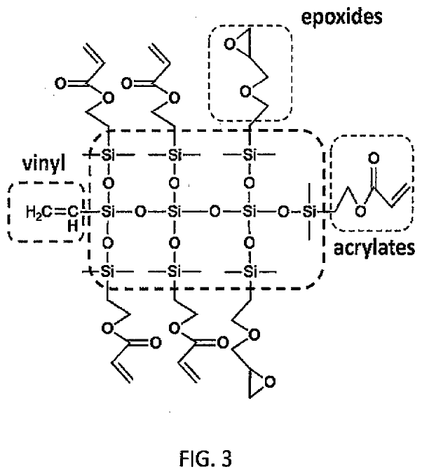

### DETAILED DESCRIPTION

In the following description, structures and methods of modification of the self-adhesive liquid silicone rubbers are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

Various processes will be described below to provide an example of at least one embodiment of the claimed subject matter. No embodiment described below limits any claimed subject matter, and any claimed subject matter may cover processes or systems that differ from those described below. The claimed subject matter is not limited to processes or systems having all of the features of any process or system described below or to features common to multiple or all of the processes or systems described below. It is possible that a process or system described below is not an embodiment of any claimed subject matter. Any subject matter that is disclosed in a process or system described below that is not claimed in this document may be the subject matter of another protective instrument, for example, a continuing patent application, and the applicants, inventors, or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

It should be noted that terms of degree such as “substantially”, “about” and “approximately” as used herein mean a reasonable amount of deviation of the modified term such that the end result is not significantly changed. These terms of degree may be construed as including a certain deviation of the modified term if this deviation would not negate the meaning of the term it modifies.

Furthermore, the recitation of numerical ranges by endpoints herein includes all numbers and fractions subsumed within that. It is also to be understood that all numbers and fractions thereof are presumed to be modified by the term “about” which means a variation up to a certain amount of the number to which reference is being made if the end result is not significantly changed.

In accordance with a first aspect of the present invention, a self-adhesive rubber composition having a tunable adhesion strength to plastic substrates is provided, comprising a commercially available liquid silicone rubber base and a self-adhesive modifier additive selected from a crosslinker selected from organosilane, organoacrylate or their derivatives; or a mixture or combination thereof. Specifically, the mass ratio of the silicone rubber substrate to the self-adhesive modifier additives ranges from 100:0.5 to 100:10.

In some embodiments, the plastic substrate is selected from polycarbonate; polybutylene terephthalate; polyetheretherketone or polyphenylsulfone.

The liquid silicone rubber base in the composition is a two-part liquid silicone rubber, where one part may be an alkenyl-containing organopolysiloxane, and the other may be a linear or branched organohydrogenpolysiloxane. The liquid silicone rubber selected may be of a food-contact grade, non-post curing grade or high transparency grade.

The organosilane crosslinker may be selected from tetraalkylorthosilicates; (epoxy-organo)trialkoxysilane or any derivatives; copolymers or mixtures thereof.

The tetraalkylorthosilicates crosslinker may have the formula of Si(OR¹)₄, wherein R¹ is a monovalent hydrocarbon selected from a linear or branched alkyl group having equal to or less than 8 carbon atoms, an alkoxy group having equal to or less than 4 carbon atoms, or a tolyl group. Further, the amount of the tetraalkylorthosilicates may be approximately 0.8 to 1.2 wt % relative to the weight of the liquid silicone rubber base.

The (epoxy-organo)trialkoxysilane crosslinker may have one of the following formulae:

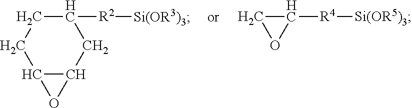

wherein R² is a divalent hydrocarbon group comprising 2 to 4 carbon atoms; R³ and R⁵ are alkyl radicals comprising 1 to 3 carbon atoms; and R⁴ is a divalent alkoxy group consisting 2 to 4 carbon atoms. Further, the amount of the (epoxy-organo)trialkoxysilane may be approximately 0.8 to 4.8 wt % relative to the weight of the liquid silicone rubber base.

The organoacrylate crosslinker may be selected from selected from ethyl acrylate; butyl acrylate; propyl acrylate; N,N-dimethylacrylamide; methacrylic acid; N-isopropyl acrylamide; 2-Hydroxy-ethyl-methacrylate; 3-[tris(trimethylsiloxy)silyl]propyl methacrylate; acrylate functional carbosilane molecule; methacrylate functional carbosilane molecule; dipentaerythritol pentaacrylate; ethoxylated pentaerythritol tetraacrylate; di-trimethylolpropane tetraacrylate; pentaerythritol triacrylate; trimethylolpropane triacrylate; ethoxylated trimethylolpropane triacrylate; or mixtures thereof. Further, the amount of the organocrylate may be approximately 0.8 to 3.6 wt % relative to the weight of the liquid silicone rubber base.

The organic peroxide curing agent may be selected from di-benzoyl peroxide; tertiary butyl perbenzoate, dicumyl peroxide; 2,5-dimethyl-2,5-bis (t-butyl peroxy)hexane; bis(2,4-dichlorobenzoyl) peroxide; di-tertiary butyl peroxide; and mixtures thereof. Further, the amount of the organic peroxide may be approximately 0.4 to 1.8 wt % relative to the weight of the liquid silicone rubber base.

The platinum-based complex curing agent may be selected from platinum black; platinic chloride; chloroplatinic acid; a reaction product of chloroplatinic acid and a monovalent alcohol; a complex of chloroplatinic acid and an olefin; or platinum bisacetoacetate. Further, the amount of the platinum-based complex may be approximately 0.5 to 1000 ppm relative to the weight of the liquid silicone rubber base.

A method of enhancing the adhesive strength of a liquid silicone rubber with the above modifier is also provided herewith. The method comprises providing a liquid silicone rubber formed with commercially available liquid silicone rubber resin and introducing a tunable amount of the modifier of claim 1 to the liquid silicone rubber via the metering unit for pigment or additives of a liquid silicone rubber processor under a temperature of 20° C. to 30° C. and pressure of 0.3 MPa to 0.6 MPa. It should be noted that through adjusting the amount of the modifier, the adhesive strength of the enhanced liquid silicone rubber may be tuned. The amount of modifier may be less than 8 wt % of the liquid silicone rubber base. This method also increases the curing time by only less than 10% compared to the curing time of an unmodified liquid silicone rubber.

The liquid silicone rubber enhanced under this method has an increased shear strength of at least 0.56 MPa, as tested under the ASTM D3163 standard (“Standard Test Method for Determining Strength of Adhesively Bonded Rigid Plastic Lap-Shear Joints in Shear by Tension Loading”), with the addition of modifier of an amount of at least 6 wt % of the liquid silicone rubber base.

Advantageously, the use of the modifiers of the present invention may be applied to commercially-available liquid silicone rubber resins. By providing a selected amount of modifier (as set forth in detail in the below examples), a liquid silicone rubber product having a specifically-determined adhesive strength can be created. In this manner, small batches of silicone products at different selected adhesive strengths may be manufactured.

### EXAMPLES

### Example 1. Results of the Versatile Self-Adhesive Modifier—Liquid Silicone Rubber (FC LR3038) Bonding

To test the degree of enhancement effected from the addition of the modifier, a commercially available liquid silicone rubber FC LR3038 is selected and used to produce an enhanced liquid silicone rubber with the method described in paragraph [0043] above is subjected to the shear strength test under the ASTM D3163 standard (“Standard Test Method for Determining Strength of Adhesively Bonded Rigid Plastic Lap-Shear Joints in Shear by Tension Loading”).

The results of the tests are tabulated below in Table 1:

TABLE 1
Results of VSM-LSR Bonding for enhanced LSR (FC LR3038)

| | Component | | | | | | | | | |
|---|---|---|---|---|---|---|---|---|---|---|
| | VSM | | | | Total | Curing time | | | | |
| | | | TMP | Catalyst | adding | Just curing | | Post-curing | | Shear |
| Plastic | TBOS | GPTES | -TA | BIPB | amount | Temp | Time | Temp | Time | Strength |
| Substrate | (phr) | (phr) | (phr) | (phr) | (wt %) | (° C.) | (min) | (° C.) | (h) | (MPa) |
| PC | 1 | 3 | 1 | 1 | 6 | 160 | 5 | 140 | 4 | 1.94 ± 0.21 |
| PBT | | | | | | | | 180 | 2 | 2.72 ± 0.66 |
| PEEK | | | | | | | | | | 1.86 ± 0.26 |
| PPSU | | | | | | | | | | 0.74 ± 0.18 |

In the above table, the abbreviations are as follows: polycarbonate (PC); polybutylene terephthalate (PBT); polyetheretherketone (PEEK); polyphenylsulfone (PPSU); tetrabutoxysilane (TBOS); (3-glycidyloxypropyl)triethoxysilane (GPTES); trimethylopropane triacrylate (TMP-TA); bis(t-butylperoxy isopropy)benzene (BIPB).

As a comparison and control, the curing time for the unmodified liquid silicone rubber FC LR3038 is 5 minutes for just curing at a temperature of 160° C.; and 4 hours for just curing at a temperature of 200° C.

### Example 2. Cost Calculation of VSM-LSR (FC LR3038)

The add-on material cost of producing the enhanced liquid silicone rubber with the versatile self-adhesive modifier in Example 1 is calculated and tabulated in Table 2 below.

TABLE 2
Cost calculation of VSM-LSR (FC LR3038)

| | | | | | | | | | Add-on |
|---|---|---|---|---|---|---|---|---|---|
| | VSM | | | | | | Catalyst | | material |
| | | Unit | TMP- | Unit | | Unit | | Unit | cost |
| | TBOS | price | TA | price | GPTES | price | BIPB | price | (HKD/kg |
| Substrate | (phr) | (HKD/g) | (phr) | (HKD/g) | (phr) | (HKD/g) | (phr) | (HKD/g) | LSR) |
| PC | 1 | 0.02 | 1 | 0.03 | 3 | 0.39 | 1 | 0.05 | 12.7 |
| PBT | | | | | | | | | |
| PEEK | | | | | | | | | |
| PPSU | | | | | | | | | |

### Example 3. Results of the Versatile Self-Adhesive Modifier—Liquid Silicone Rubber (NP CHN2003) Bonding

To test the degree of enhancement effected from the addition of the modifier, a commercially available liquid silicone rubber NP CHN2003 is selected and used to produce an enhanced liquid silicone rubber with the method described in paragraph [0043] above is subjected to the shear strength test under the ASTM D3163 standard (“Standard Test Method for Determining Strength of Adhesively Bonded Rigid Plastic Lap-Shear Joints in Shear by Tension Loading”).

The results of the tests are tabulated below in Table 3:

TABLE 3
Results of VSM-LSR Bonding for enhanced LSR (NP CHN2003)

| | Component | | | | | | | |
|---|---|---|---|---|---|---|---|---|
| | VSM | | | | Total | Curing time | | |
| | | | TMP- | Catalyst | adding | Just curing | | |
| Plastic | TBOS | GPTES | TA | BIPB | amount | Temp | Time | Shear strength |
| Substrate | (phr) | (phr) | (phr) | (phr) | (wt %) | (° C.) | (min) | (MPa) |
| PC | 1 | 3 | 1 | 1 | 6 | 160 | 10 | 1.76 ± 0.37 (n = 5) |
| PBT | | | | | | | | 1.84 ± 0.35 (n = 5) |
| PEEK | | | | | | | | 1.69 ± 0.19 (n = 5) |
| PPSU | | | | | | | | 0.99 ± 0.09 (n = 5) |

As a comparison and control, the curing time for the unmodified liquid silicone rubber NP CHN2003 is 10 minutes for just curing at a temperature of 120° C.

### Example 4. Cost Calculation of VSM-LSR (NP CHN2003)

The add-on material cost of producing the enhanced liquid silicone rubber with the versatile self-adhesive modifier in Example 1 is calculated and tabulated in Table 4 below.

TABLE 4
Cost calculation of VSM-LSR (NP CHN2003)

| | | | | | | | | | Add-on |
|---|---|---|---|---|---|---|---|---|---|
| | VSM | | | | | | Catalyst | | material |
| | | Unit | TMP- | Unit | | Unit | | Unit | cost |
| | TBOS | price | TA | price | GPTES | price | BIPB | price | (HKD/kg |
| Substrate | (phr) | (HKD/g) | (phr) | (HKD/g) | (phr) | (HKD/g) | (phr) | (HKD/g) | LSR) |
| PC | 1 | 0.02 | 1 | 0.03 | 3 | 0.39 | 1 | 0.05 | 12.7 |
| PBT | | | | | | | | | |
| PEEK | | | | | | | | | |
| PPSU | | | | | | | | | |

It will be appreciated by those skilled in the art, in view of these teachings, that alternative embodiments may be implemented without deviating from the spirit or scope of the invention, as set forth in the appended claims. This invention is to be limited only by the following claims, which include all such embodiments and modifications when viewed in conjunction with the above specification and accompanying drawings.

1. A self-adhesive silicone rubber composition having a tunable adhesion strength to plastic substrates, comprising:
a commercially available common liquid silicone rubber base; and
a self-adhesive modifier additive selected from:
a crosslinker selected from organosilane, organoacrylate or their derivatives;
a curing agent selected from a platinum-based complex, an organic peroxide or its derivatives; or
a mixture or combination thereof;
wherein the mass ratio of the silicone rubber substrate to the self-adhesive modifier additives ranges from 100:0.5 to 100:10.

2. The silicone rubber composition of claim 1, wherein the plastic substrate is selected from polycarbonate; polybutylene terephthalate; polyetheretherketone or polyphenylsulfone.

3. The silicone rubber composition of claim 1, wherein the liquid silicone rubber base comprises two components, wherein one is alkenyl-containing organopolysiloxane and the other is linear or branched organohydrogenpolysiloxane.

4. The rubber composition of claim 1, wherein the liquid silicone rubber base is selected from food-contact grade liquid silicone rubber; non-post curing liquid silicone rubber or high transparency liquid silicone rubber.

5. The silicone rubber composition of claim 1, wherein the organosilane is selected from tetraalkylorthosilicates; (epoxy-organo)trialkoxysilane or any derivatives; copolymers or mixtures thereof.

6. The silicone rubber composition of claim 5, wherein the tetraalkylorthosilicates has the formula of Si(OR¹)₄, wherein R¹ is a monovalent hydrocarbon selected from:
a linear or branched alkyl group having equal to or less than 8 carbon atoms;
an alkoxy group having equal to or less than 4 carbon atoms; or;
a tolyl group.

7. The silicone rubber composition of claim 5, wherein the (epoxy-organo)trialkoxysilane has one of the following formulae: 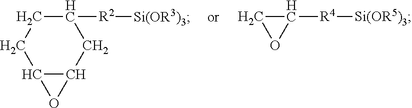
wherein R² is a divalent hydrocarbon group comprising 2 to 4 carbon atoms;
R³ and R⁵ are alkyl radicals comprising 1 to 3 carbon atoms; and
R⁴ is a divalent alkoxy group consisting 2 to 4 carbon atoms.

8. The silicone rubber composition of claim 1, wherein the organoacrylate is selected from ethyl acrylate; butyl acrylate; propyl acrylate; N,N-dimethylacrylamide; methacrylic acid; N-isopropyl acrylamide; 2-Hydroxy-ethyl-methacrylate; 3-[tris(trimethylsiloxy)silyl]propyl methacrylate; acrylate functional carbosilane molecule; methacrylate functional carbosilane molecule; dipentaerythritol pentaacrylate; ethoxylated pentaerythritol tetraacrylate; di-trimethylolpropane tetraacrylate; pentaerythritol triacrylate; trimethylolpropane triacrylate; ethoxylated trimethylolpropane triacrylate; or mixtures thereof.

9. The silicone rubber composition of claim 1, wherein the organic peroxide is selected from di-benzoyl peroxide; tertiary butyl perbenzoate, dicumyl peroxide; 2,5-dimethyl-2,5-bis (t-butyl peroxy)hexane; bis(2,4-dichlorobenzoyl) peroxide; di-tertiary butyl peroxide; and mixtures thereof.

10. The silicone rubber composition of claim 1, wherein the platinum-based complex is selected from platinum black; platinic chloride; chloroplatinic acid; a reaction product of chloroplatinic acid and a monovalent alcohol; a complex of chloroplatinic acid and an olefin; or platinum bisacetoacetate.

11. A method of enhancing the adhesive strength of a liquid silicone rubber with the modifier of claim 1, comprising:
providing a liquid silicone rubber formed with commercially available common liquid silicone rubber resin; and
introducing a tunable amount of the modifier of claim 1 to the liquid silicone rubber via the metering unit for pigment under a temperature of 20° C. to 30° C. and pressure of 0.3 MPa to 0.6 MPa;
wherein the adhesive strength of the enhanced liquid silicone rubber is tunable through adjusting the amount of the modifier of claim 1;
wherein the amount of modifier is less than 10 wt % of the liquid silicone rubber base; and
wherein the curing time is less than 10% longer than that of an unmodified liquid silicone rubber.

12. The method of claim 11, wherein the shear strength of the enhanced liquid silicone rubber is at least 0.6 MPa with the addition of modifier of at most 10 wt % of the liquid silicone rubber base.
